(19) United States
(12) Patent Application Publication
(10) Pub. No.: US 2014/0223882 A1
(43) Pub. Date: Aug. 14, 2014

(54) SYSTEMS AND METHODS FOR COAL BENEFICIATION

(71) Applicant: GENERAL ELECTRIC COMPANY, Schenectady, NY (US)

(72) Inventors: Vijayalakshmi Shah, Bangalore (IN); Sudharsanam Krishnamachari, Bangalore (IN); Annavarapu Vijay Bharat Sastri, Bangalore (IN); Ankur Verma, Bangalore (IN)

(73) Assignee: General Electric Company, Schenectady, NY (US)

(21) Appl. No.: 13/764,774

(22) Filed: Feb. 11, 2013

(51) Int. Cl. F02C 3/28; C10B 31/00; F23D 14/66; F23D 1/00; F23D 1/02

(52) U.S. Cl. CPC F02C 3/28; F23D 1/005; F23D 1/02; F23D 14/66; C10B 31/00
USPC 60/39.12; 110/263; 110/218; 431/161; 110/229; 110/347; 431/11; 110/342; 201/22

(57) ABSTRACT

A system includes a feed preparation system, with a fluid injection system configured to inject a fluid into a feed stream to generate a feed-fluid mixture. The feed stream includes a first solid, a second solid, and a gas. The feed preparation system also includes a cyclone configured to separate the feed-fluid mixture into a first stream that includes the first solid and the gas, and a second stream that includes the second solid and the fluid.

### BACKGROUND

The subject matter disclosed herein relates to coal beneficiation and, more specifically, to the separation of ash from the coal in a coal gasification system.

Synthesis gas, or syngas, is a mixture of hydrogen (H₂) and carbon monoxide (CO) that can be produced from carbonaceous fuels. Syngas can be used directly as a source of energy (e.g., in combustion turbines), or can be used as a source of starting materials for the production of other useful chemicals (e.g., methanol, formaldehyde, acetic acid). Syngas is produced in large scale by gasification systems, which include a gasification reactor or gasifier that subjects a carbonaceous fuel, such as coal, and other reactants to certain conditions to produce an untreated or raw syngas. To increase the efficiency of the gasification reaction, the ratio of combustible molecules derived from coal to non-combustible scrap, such as ash, within the gasifier is typically maintained within a desired range.

Coal may be collected from various sources, which can lead to different ranks, or qualities, of the coal. Generally, low-rank coals will have higher ash content, while high-rank coking coals have lower ash content. Unfortunately, some geographic sources of coal only extract low-rank coal that may reduce the ability to produce syngas using a typical set of conditions for coal of different or higher rank. As a result, these low-rank coals are particularly problematic and difficult to use, yet their availability would be particularly useful if the ash could be separated from the coal in a simple and cost effective manner. Through the systems and methods described below, low-rank coal may be beneficiated so that it may be used where currently only high-rank coal is being used. Such applications include gasification of coal into syngas, or burning the coal to produce thermal energy. In instances where the coal is not gasified, the beneficiated coal resulting from the processes described below may be used in applications that currently use coking coal.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a feed preparation system, with a fluid injection system configured to inject a fluid into a feed stream to generate a feed-fluid mixture. The feed stream includes a first solid, a second solid, and a gas. The feed preparation system also includes a cyclone configured to separate the feed-fluid mixture into a first stream that includes the first solid and the gas, and a second stream that includes the second solid and the fluid.

In a second embodiment, a system includes a coal beneficiation system that includes a conduit configured to convey coal particles, ash particles, and a conveyance gas. Furthermore, the coal beneficiation system includes a fluid sprayer configured to spray droplets of fluid onto the coal particles and ash particles being conveyed in the conduit and a cyclone configured to generate a coal stream that includes the coal particles and the conveyance gas, and an ash stream that includes the ash particles.

In a third embodiment, a method includes conveying coal particles, ash particles, and a conveyance gas in a conduit, spraying fluid droplets onto the coal particles and ash particles using a fluid sprayer, and generating using a cyclone a coal stream that includes the coal particles and the conveyance gas, and an ash stream that includes the ash particles.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an embodiment of a coal gasification system, including a coal beneficiation system;

FIG. 2 illustrates a more detailed view of an embodiment of the coal beneficiation system of the coal gasification system illustrated in FIG. 1;

FIG. 3 illustrates an embodiment of coal beneficiation; and

FIG. 4 illustrates a flow chart of an embodiment of a method of beneficiating coal.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed below, in embodiments where solid fuel used for syngas production includes a low-rank coal, the solid fuel (i.e., coal) may have unsuitably high amounts of ash, and may have anisotropic concentrations of carbonaceous fuel. This can lead to large temperature variations or other variations within a gasifier and associated equipment, which calls for robust process control systems. To reduce variations such as these, the present embodiments are generally directed toward a dry beneficiation vessel, such as a cyclone, which is configured to deliver a high-rank, consistent feed of a solid fuel, such as coal. The cyclone, in certain embodiments, may include a sprayer that is configured to increase separation of the ash and the solid carbonaceous fuel by increasing the mass differences between the ash and the fuel within the vessel.

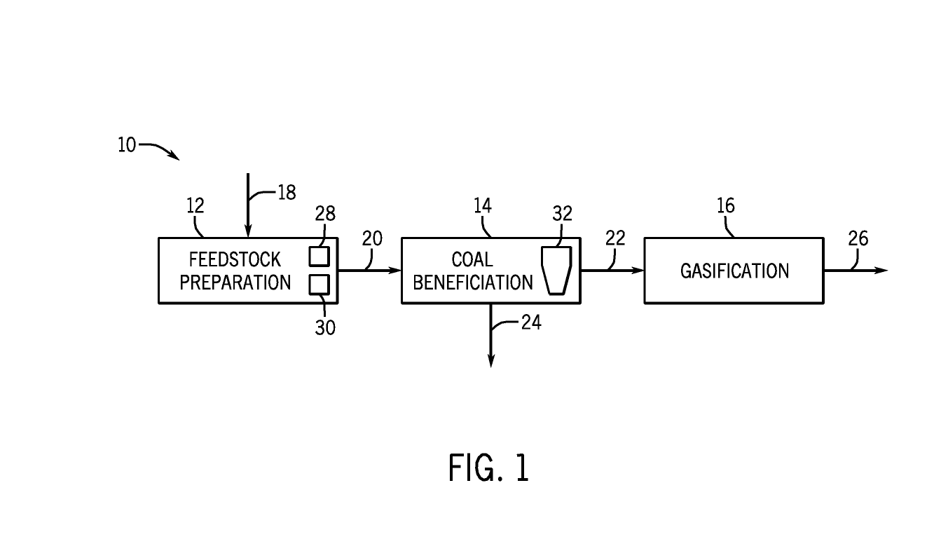

FIG. 1 illustrates a block diagram of a syngas generation system 10 which may be part of an integrated gasification combined cycle (IGCC) power plant. IGCC power plants are a highly used method for turning coal and other carbon-based fuels into electrical energy. IGCCs include a gasifier, a gas treatment system, gas turbine, steam turbine, and heat recovery steam generator (HRSG). Alternative embodiments for the coal beneficiation systems and methods include thermal power generation structures that may use the ungasified coal to generate heat and energy. While most of the description below is focused on syngas generation, the same techniques may be used to produce coal dust for use in boilers, furnaces, or other applications that require high-rank coal. The syngas generation system 10 has a feedstock preparation system 12, a coal beneficiation system 14, and a coal gasification system 16. According to certain aspects of the present embodiments discussed in further detail below, the feedstock preparation system 12 reduces a carbonaceous fuel source 18 into an ultra-fine (e.g., less than about 1 mm) carbonaceous fuel mixture 20, which includes particles of mostly small and uniform size. The coal beneficiation system 14 receives the ultra-fine carbonaceous fuel mixture 20 and separates it into gasifiable fuel dust 22 and ungasifiable waste 24. The coal dust is then burned in thermal power generation structures, or is gasified into syngas 26 by the gasification system 16.

The carbonaceous fuel source 18, such as a solid coal feed, may be utilized as a source of energy and/or for the production of syngas or substitute natural gas (SNG). In some embodiments, the fuel source 18 may include coal, petroleum coke, biomass, wood-based materials, agricultural wastes, tars, coke oven gas, asphalt, or other carbon-containing materials. The solid fuel of the fuel source 18 may be passed to the feedstock preparation system 12. The feedstock preparation system 12 may include several subsystems. For example, the feedstock preparation system 12 may perform resizing 28 or dry mixing 30 of the fuel source 18. Resizing, as done by the feedstock preparation system 12 may include, by way of example, use of a grinder, chopper, mill, shredder, pulverizer, or other feature for resizing or reshaping the fuel source 18 by chopping, milling, shredding, briquetting, pelletizing, pulverizing, or atomizing the fuel source 18 to generate feedstock. In the current embodiment, resizing creates the fuel mixture 20, which is typically fine or ultra-fine (e.g., less than about 1 mm) for gasification in the gasification system 16. As defined herein, dry mixing 30 includes processes in which a solid, such as a solid fuel (e.g., coal) is agitated without adding a substantial amount of moisture. Dry mixing adds air or other gases (e.g., inert gases) to the fuel mixture 20, and may be accomplished using gas flows that are substantially free of moisture, or using mechanical agitation features, such as a screw conveyor. As defined herein, substantially free of moisture denotes mixtures, such as gaseous mixtures, which include approximately 5 to 10 percent or less of water or water vapor. As an example, dry mixing with gas may include dry mixing using air, nitrogen, carbon dioxide, helium (He), argon (Ar), neon (Ne), or any combination thereof. Dry mixing also stirs up the fuel mixture 20, which prevents channeling and disperses the particles as they travel to the coal beneficiation system 14. In accordance with present embodiments, no fluid (e.g., water, steam) is added to the fuel source 18 in the feedstock preparation system 12, thus yielding dry feedstock.

The coal beneficiation system 14 includes a cyclone 32, which takes advantage of the differences in mass and density between materials to separate them. As described below, the cyclone 32 separates the fuel dust 22 from the waste 24 by ejecting the lighter material out of the top of the cyclone 32 and allowing the heavier material to drop out of the bottom of the cyclone 32. In embodiments described below, the lighter material is typically the fuel dust 22 while the waste 24 is heavier, and thus drops out of the bottom of the cyclone 32. In previous gasification systems, the high amount of waste 24 contained in some coal types prevented the coal from being used in syngas generation systems 10. The separation methods outlined below, allow a wider variety of coal types to be used as the fuel source 18 in the syngas generation system 10.

As noted above, the flow of fuel dust 22 is provided to the gasification system 16, such as a gasifier, wherein the gasifier may convert the solid fuel into a combination of CO and H₂, i.e., syngas. This conversion may be accomplished by subjecting the solid fuel to a controlled amount of steam and oxygen at elevated pressures, e.g., from approximately 20 bar to 85 bar, and temperatures, e.g., approximately 700° C. to 1600° C., depending on the type of gasifier utilized. The gasification process may also include the solid fuel undergoing a pyrolysis process, whereby the feedstock is heated. Temperatures inside the gasification system 16 may range from approximately 150° C. to 700° C. during the pyrolysis process, depending on the fuel source 18 utilized to generate the flow of the fuel dust 22. The heating of the feedstock during the pyrolysis process may generate a solid, e.g., char, and residue gases, e.g., CO, H₂, and N₂. A partial oxidation process may then occur in the gasification system 16. To aid with this partial oxidization process, a stream of oxygen may be supplied to the gasification system 16. The temperatures during the partial oxidization process may range from approximately 700° C. to 1600° C. Next, steam may be introduced in a controlled amount into the gasification system 16 during a gasification step. The char may react with the CO₂ and steam to produce CO and H₂ at temperatures ranging from approximately 800° C. to 1100° C. In essence, the system utilizes steam and oxygen to allow some of the feedstock to be partially oxidized to produce CO₂ and energy, thus driving a main reaction that converts further feedstock to H₂ and additional CO.

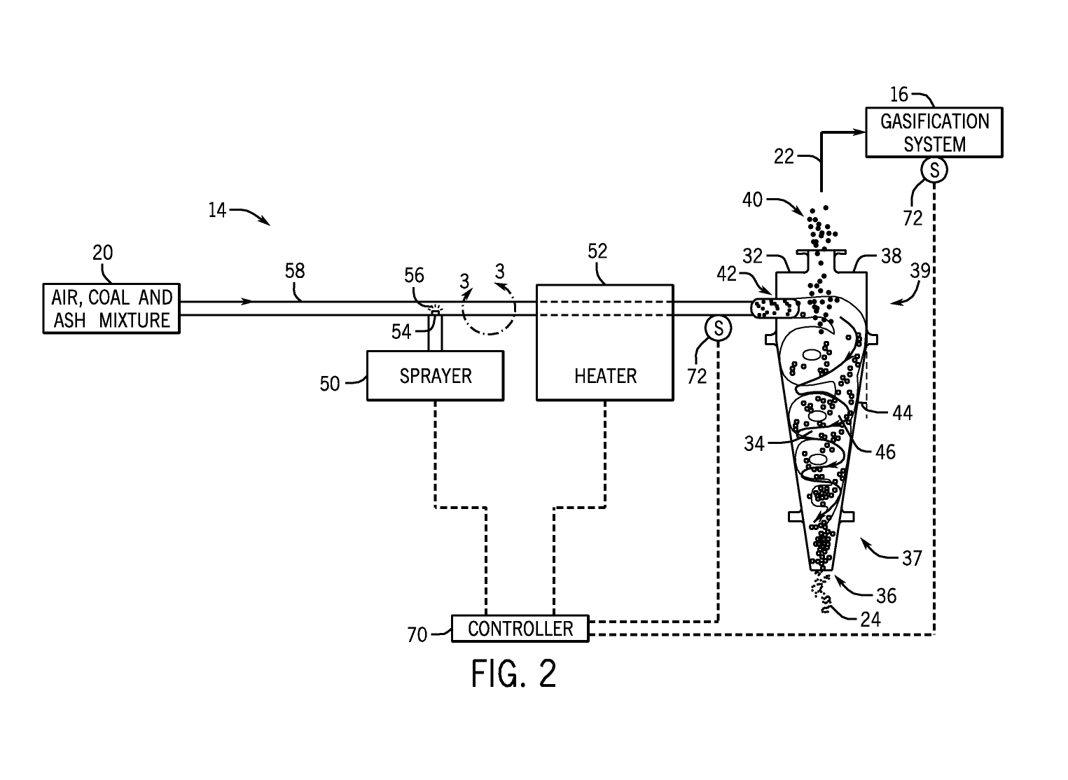

FIG. 2 illustrates a detailed diagram of an embodiment of the coal beneficiation system 14. The beneficiation system 14 includes the cyclone 32, e.g., a gravitational separation system. The cyclone 32 includes a housing 34 (e.g., a tapered housing), which has a discharge opening 36 at a lower end 37 and a cover 38 at a upper end 39. The cover 38 has an upper outlet opening 40. The cyclone 32 further includes an inlet opening 42 in the housing 34. The inlet opening 42 may be at the upper end 39 of the housing 34. In certain embodiments, the inlet opening 42 may be coupled tangentially to the housing 34 to enable tangential entry of the fuel mixture 20 from a conduit 58 that conveys the fuel mixture 20 from the feedstock preparation system 12, thereby inducing a swirling flow of the fuel mixture 20 into the housing 34. The lower end 37 of the housing 34 may be conical or gradually decreasing in diameter, and includes a taper angle 44 that may vary depending on various factors, such as composition of the fuel mixture 20, speed of entry from the opening 42, and so forth. As the fuel mixture 20 enters the cyclone 32 through the inlet opening 42, the conical or tapered shape of the housing 34 (e.g., converging wall 35) causes the material to collide against the housing 34 as it spirals (e.g., swirling flow) downward toward the discharge opening 36. A tangential opening also encourages the fuel mixture 20 to collide, and remain in contact, with the housing 34. At the same time, the beneficiation system 14 ejects air (and/or other gases) and particles through the upper outlet opening 40. Heavier particles are more susceptible to the apparent centripetal force pushing against the housing 34 of the cyclone 32 and therefore are more likely to travel along a path 46 and drop out of the discharge opening 36. On the other hand, lighter particles and gases are more likely to float up and travel through the upper outlet opening 40. In the embodiment shown in FIG. 2, the heavier particles include ash and the waste 24, while the lighter particles include the gasifiable fuel dust 22.

For ultra-fine dust like that used in the current embodiment, the accuracy of the cyclone 32 can decrease due to the small differences in mass between the particles. This is especially true when the differences in density are small to begin with. To increase the differences in mass between the waste 24 and the fuel dust 22, the coal beneficiation system 14 may also include a sprayer 50 and a heater 52. The sprayer 50 includes a nozzle 54 that delivers a fluid 56, such as water, steam, saturated steam, oil, or other liquids or gases into the conduit 58 along which the fuel mixture 20 is traveling.

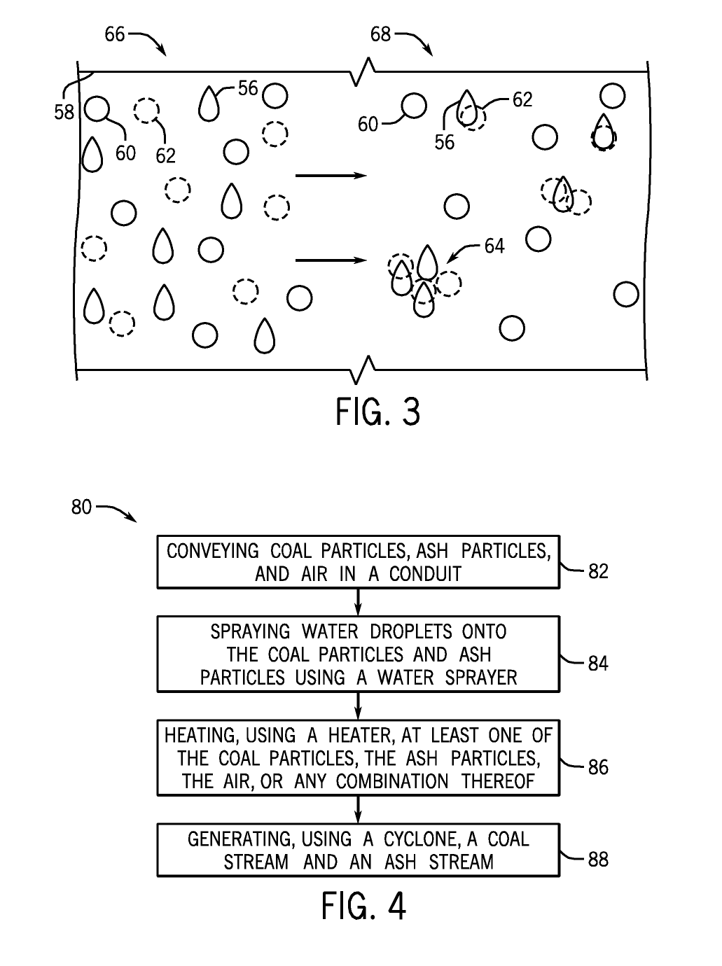

As shown in FIG. 3, the fluid 56 utilizes the significant differences in the surface properties of the carbon particles 60 and noncarbon particles 62. Carbon particles 60 are hydrophobic and repel water, steam, and other fluids and liquids with similar chemical properties. The noncarbon particles 62, typically silica or ash, that come from fuel sources 18 are hydrophilic and attract water, steam, and other fluids and liquids with similar chemical properties. FIG. 3 shows the conduit 58 after the sprayer 50 has injected the fluid 56 into the conduit 58. At a first time 66, the fluid 56, carbon 60, and noncarbon 62 particles may be suspended in the gas provided during dry mixing 30. Due to the surface properties of the particles, however, the fluid 56 is repelled by the carbon particles 60 while at the same time it is attracted and adheres to the noncarbon particles 62. Thus, at a second time 68, the fluid 56 increases the mass of noncarbon particles 62 and may cause the particles 62 to stick to one another. A cluster 64 of noncarbon particles 62 and fluid 56 is heavier and thus, more likely to drop through the cyclone 32 and out through the discharge opening 36.

Referring back to FIG. 2, the fuel mixture 20, either before or after passing sprayer 50, may also pass through one or more optional heater 52, which heats the fuel mixture 20 to remove any fluid 56 that may have attached to the coal particles 60. The heater 52 may be any type of heater including, but not limited to, a microwave heater, an infrared heater, an induction heater, a micathermic heater, a solar heater, a heat exchanger (e.g., fin and tube heat exchanger) or any combination thereof. In one embodiment, the heater 52 includes a microwave heater, which again takes advantage of the differences between carbon and the noncarbon particles present in the fuel mixture 20. One minute of microwave heating is believed to heat carbon to around about 1200 degrees C. Silica, on the other hand, may only reach around about 90 degrees C. after one minute of similar microwave heating. As mentioned above, silica is a typical impurity in many coal-based fuel sources 18 and thus, a microwave heater 52 would provide a significant temperature difference between the carbon particles 60 and the noncarbon particles 62 in the fuel mixture 20. In certain embodiments, the heater 52 may use variable frequency microwaves to increase efficiency and avoid problems such as hot and cold spots, and arcing to metal that may arise from use of microwaves. The temperature difference would allow any fluid 56 adhered to the carbon particles 60 to evaporate or vaporize, thus, increasing the differences in mass of the carbon particles 60 and the noncarbon particles 62.

FIG. 2 also shows a controller 70 configured to monitor and adjust parameters within the beneficiation system 14. The controller 70 may receive signals from sensors 72 that monitor the flow rate and composition of the fuel mixture 20, or the separated fuel dust 22 as it enters or is gasified in the gasification system 16. Sensors include, but are not limited to, a water flow sensor, a heater temperature sensor, a downstream gasification sensor, a coal stream composition sensor, or an ash stream composition sensor, or any combination thereof. The controller 70 may then adjust the sprayer 50, the heater 52, or both to compensate for reduced efficiency detected by the sensors 72. For example, the controller 70 may increase or decrease the amount, or flow rate, of fluid 56 being sprayed into the conduit 58, or may vary the type of spray. The nozzle 54 may adjust to form a more atomized mist or may spray a wetter drizzle into the fuel mixture 20. The controller 70 may also control aspects of the heater 52 to increase the efficiency of the cyclone 32 and increase separation. In some embodiments, the heater may not be necessary at all, relying merely on the hydrophobic and hydrophilic properties of the carbon particle 60 and noncarbon particle 62 in the fuel mixture 20 to provide separation. In other embodiments, the controller 70 may increase or decrease the heating power or duration to provide the best separation of the fuel mixture 20 into fuel dust 22 and waste 24.

FIG. 4 illustrates a flow diagram of a process 80 by which a system (e.g., the syngas generation system 10 described above) may beneficiate coal into fuel dust 22 and waste 24. The illustrated process 80 begins with the syngas generation system 10 conveying 82 the fuel mixture 20 of coal, ash, and air in conduit 58. Next, the coal beneficiation system 14 of the syngas generation system 10 may spray 84 water droplets (or other fluid droplets) onto the fuel mixture 20. The coal beneficiation system 14 may use a water sprayer 50 to spray water droplets, such as mist, steam, or saturated steam, onto the fuel mixture 20. The coal beneficiation system 14 may heat 86 the coal particles, the ash particle, the air, or any combination thereof. Heating may be performed by the heater 52 either before spraying, during spraying, or after spraying has been done by the sprayer 50 of the beneficiation system 14. Also, the cyclone 32 within the coal beneficiation system 14 generates 86 a coal stream including the coal particles and the air, and generates a separate ash stream including the ash particles. By doing so, as discussed in detail above, the syngas generation system 10 creates a dust fuel 22 that may be gasified into syngas 26, wherein the fuel 22 has a substantially reduced percentage of ash content.

Technical effects of the invention include the preparation of a fuel source 18 into a fuel mixture 20. The fuel mixture 20 is typically reduced to fine or ultra-fine particles of carbonaceous fuel dust and noncarbonaceous waste. The disclosed embodiments also include the beneficiation of the fuel mixture 20 into the fuel dust 22 and the waste 24. Beneficiation is accomplished using the cyclone separator 32 to separate the dusts based on the difference in mass. Coal beneficiation systems disclosed may include the fluid sprayer 50 and the heater 52 to magnify the physical and chemical differences between the carbonaceous and noncarbonaceous particles. The syngas generation system 10 described in the disclosed embodiments also allows for the gasification of the carbonaceous fuel dust into syngas. The syngas generation system 10 may be included within an IGCC power plant.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a feed preparation system, comprising:
a fluid injection system configured to inject a fluid into a feed stream to generate a feed-fluid mixture, wherein the feed stream comprises a first solid, a second solid, and a gas; and
a cyclone configured to separate the feed-fluid mixture into a first stream comprising the first solid and the gas, and a second stream comprising the second solid and the fluid.

2. The system of claim 1, comprising a thermal power generator.

3. The system of claim 1, wherein the first solid comprises coal particles and, the second solid comprises ash particles.

4. The system of claim 3, wherein the fluid injection system comprises a sprayer configured to spray droplets of the fluid, a mist of the fluid, or combination thereof onto the coal particles and the ash particles.

5. The system of claim 1, wherein the cyclone comprises a tangential inlet nozzle configured to receive the feed-fluid mixture, wherein the tangential inlet nozzle causes the feed-fluid mixture to swirl within the cyclone.

6. The system of claim 1, comprising a heater configured to heat at least one of the feed stream, the gas, or the feed-fluid mixture, or any combination thereof to facilitate separation of the feed-fluid mixture in the cyclone.

7. The system of claim 6, wherein the heater is configured to heat the coal particles to a first temperature and heat the ash particles to a second temperature, wherein the first temperature is greater than the second temperature.

8. The system of claim 6, wherein the heater comprises at least one of a microwave heater, an infrared heater, an induction heater, micathermic heater, or solar heater, or any combination thereof.

9. The system of claim 1, comprising a gasifier configured to gasify the first stream.

10. The system of claim 8, comprising an integrated gasification combined cycle (IGCC) power plant having the feed preparation system and the gasifier.

11. A system, comprising:
a coal beneficiation system, comprising:
a conduit configured to convey coal particles, ash particles, and a conveyance gas;
a fluid sprayer configured to spray fluid onto the coal particles and ash particles being conveyed in the conduit; and
a cyclone configured to generate a coal stream comprising the coal particles and the conveyance gas, and an ash stream comprising the ash particles.

12. The system of claim 11, comprising a heater configured to heat at least one of the coal particles, the ash particles, or the conveyance gas, or any combination thereof to facilitate separation of the feed-fluid mixture in the cyclone.

13. The system of claim 12, wherein the heater is configured to heat the coal particles to a first temperature and heat the ash particles to a second temperature, wherein the first temperature is greater than the second temperature.

14. The system of claim 12, wherein the heater comprises at least one of a microwave heater, an infrared heater, an induction heater, micathermic heater, or solar heater, or any combination thereof.

15. The system of claim 12, comprising a controller configured to adjust a component of at least one of the fluid sprayer, or the heater, or a combination thereof, based on a received signal from a sensor to achieve a target separation of the coal particles and the ash particles in the cyclone.

16. The system of claim 15, wherein the sensor comprises at least one of a fluid flow sensor, a heater temperature sensor, a downstream gasification sensor, a coal stream composition sensor, or an ash stream composition sensor, or any combination thereof.

17. A method, comprising:
conveying coal particles, ash particles, and a conveyance gas in a conduit;
spraying fluid onto the coal particles and ash particles using a fluid sprayer; and
generating, using a cyclone, a coal stream comprising the coal particles and the conveyance gas, and an ash stream comprising the ash particles.

18. The method of claim 17, comprising heating at least one of the coal particles, the ash particles, or the conveyance gas, or any combination thereof, with a heater disposed upstream or downstream of the fluid sprayer.

19. The method of claim 17, comprising gasifying the coal stream using a gasifier.

20. The method of claim 17, comprising generating the coal particles and ash particles using at least one of a grinder, a sieve, a chopper, a mill, a shredder, or a pulverizer, or any combination thereof.
